(19) United States
(12) Patent Application Publication
(10) Pub. No.: US 2014/0011381 A1
(43) Pub. Date: Jan. 9, 2014

(54) CARD CONNECTOR WITH CARD EJECTION MECHANISM

(71) Applicant: ZHI-QIANG LIANG, Shenzhen City (CN)

(72) Inventor: ZHI-QIANG LIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/593,536

(22) Filed: Aug. 24, 2012

(30) Foreign Application Priority Data
Jul. 4, 2012 (CN) 201210229557.3

(51) Int. Cl. H01R 13/62

(52) U.S. Cl. 439/159

(57) ABSTRACT

A card connector includes a housing defining a receiving space with an entrance, an ejection member, a resilient member received in the receiving space, and a latching member slidable to the housing. The ejection member includes an ejection portion slidable in the receiving space and an engaging portion comprising an engaging surface. The resilient member applies a push force to the ejection member to move the ejection member toward the entrance. The latching member includes a latching portion comprising a latching surface. When the electrical card is inserted into the receiving space, the electrical card drives the latching member to slide to a first position where latching surface lockingly engages with the engaging surface. When the electrical card is further pushed into the receiving space, the electrical card drives the latching member to slide to a second position where the latching surface disengages from the engaging surface.

### BACKGROUND

1. Technical Field

The present disclosure relates to card connectors, and particularly to a card connector with a card ejection mechanism.

2. Description of Related Art

Electrical cards, such as an SIM cards and flash memory cards, are provided to enhance the function of an electronic device, e.g. a mobile phone. Thus, a card connector is provided to the electronic device for accommodating the electrical card. Although conventional card connectors can eject the electrical card out when pushing the electrical card, a card connector with a new card ejection mechanism is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a card connector including a latching member in accordance with an exemplary embodiment.

FIG. 2 is an exploded, isometric view of the card connector shown in FIG. 1.

FIG. 3 is an isometric view of the latching member shown in FIG. 1.

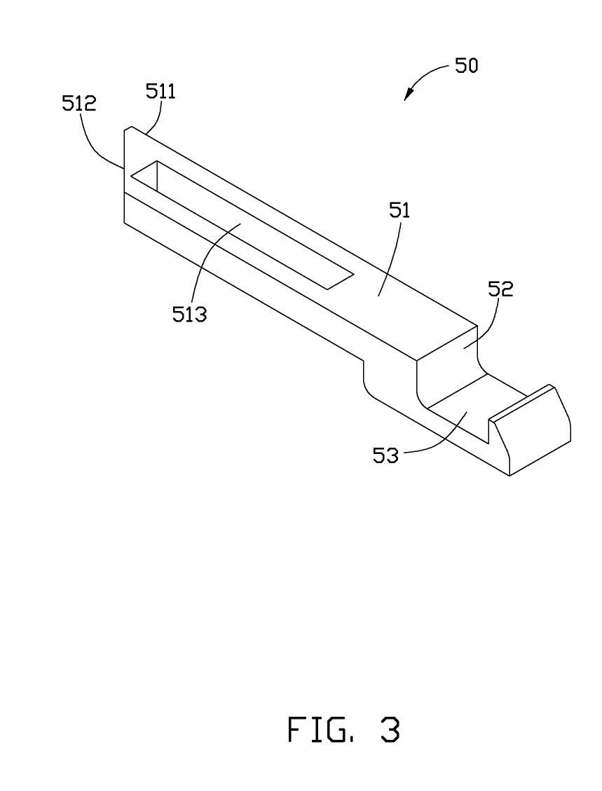

FIG. 4 is an isometric view of the card connector shown in FIG. 1 and an electrical card inserted into the card connector.

FIG. 5 is an isometric view of the card connector and the electrical card shown in FIG. 4, wherein the latching member is in a first position.

FIG. 6 is an isometric view of the card connector and the electrical card shown in FIG. 4, wherein the latching member is in a second position.

### DETAILED DESCRIPTION

Embodiments of the present disclosure are described with reference to the accompanying drawings.

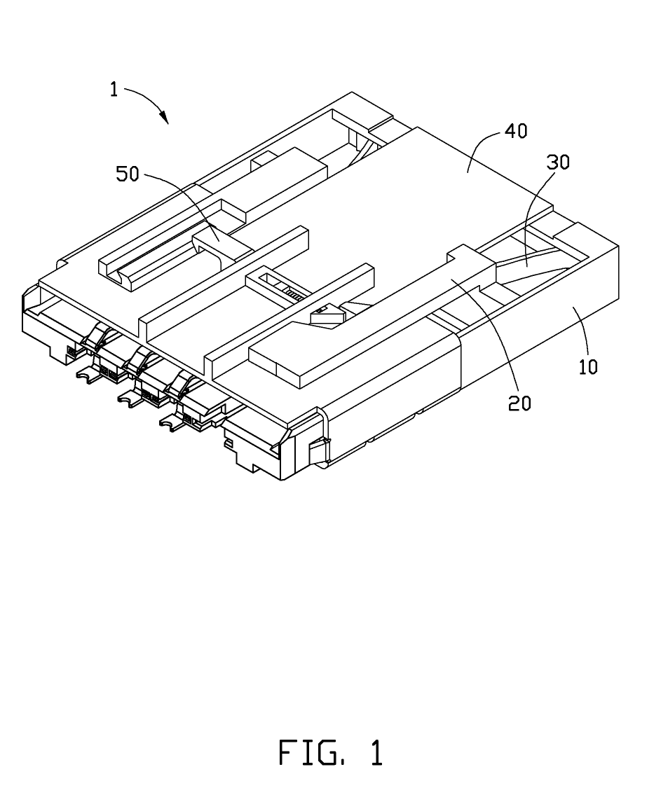

Referring to FIG. 1, a card connector 1 in accordance with an exemplary embodiment is illustrated. The card connector 1, in the illustrated embodiment, is a card socket. The card connector 1 includes a housing 10, an ejection member 20, a resilient member 30, a covering plate 40, a latching member 50, and a spring 60.

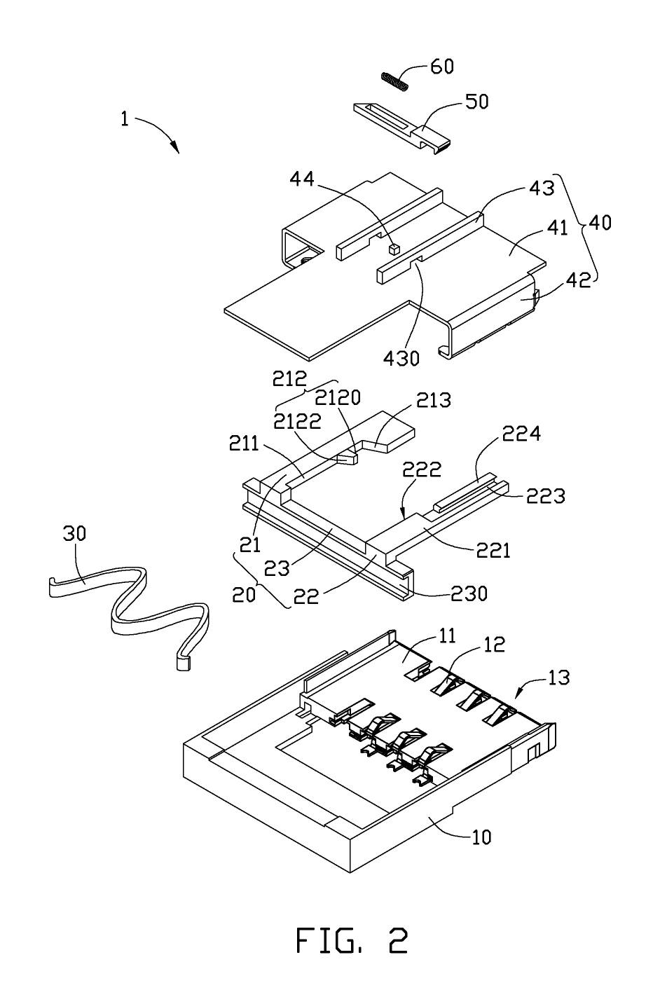

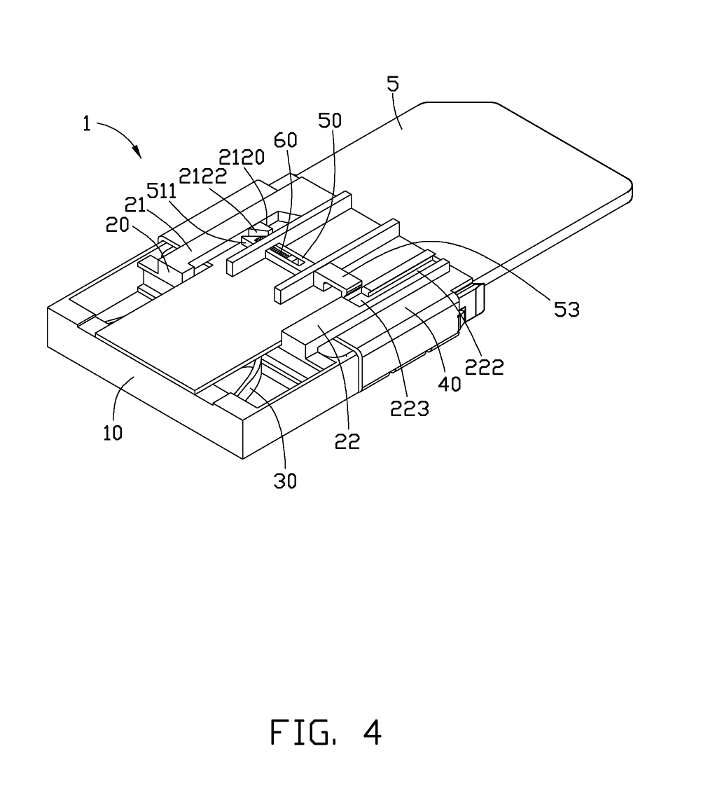

Referring also to FIG. 2, the housing 10 defines a receiving space 11 for receiving an electrical card 5 (FIG. 4) and a number of contacts 12 for electrically contacting corresponding contacts of the electrical card 5. The receiving space 11 includes an entrance 13 for inserting the electrical card 5 into the receiving space 11. The electrical card 5 may be a storage card, for example, a SD card,

The ejection member 20 includes an ejection portion 23, a first arm 21, and a second arm 22. The ejection portion 23 is slidable in the receiving space 11 of the housing 10 in a first direction. The first arm 21 and the second arm 22 are connected to two opposite ends of the ejection portion 23. The first arm 21 includes a first side surface 211 facing the second arm 22, an engaging portion 212 protruding from the first side surface 211, and a first surface 213 obliquely oriented relative to the first direction. The engaging portion 212 includes an engaging surface 2120 substantially perpendicular to the first direction and a second surface 2122 substantially parallel to the first surface 213. The second arm 22 includes an upper surface 221 and a second side surface 222 facing the first arm 21. The upper surface 221 defines an L-shaped slot 223 with an open end formed in the second side surface 222, thereby forming an elongated bar 224. The ejection portion 23 is slidably retained within the receiving space 11 of the housing 10. The ejection portion 23 defines a flute 230 opposite to the first arm 21 and the second arm 22.

The resilient member 30 is received in the receiving space 11 of the housing 100 and compressed between the housing 10 and the ejection member 20. In the embodiment, the resilient member 30 is wave-shaped which can be received in the flute 230 of the ejection member 20. Then the resilient member 30 applies a push force to the ejection member 20.

The covering plate 40 includes a middle plate 41, two side plates 42 protruding downwardly from the middle plate 41, two guide blocks 43, and a positioning block 44 protruding upwardly from the middle plate 41. The side plates 42 are fixed to the housing 10, and the guide blocks 43 each define a guide hole 430 aligned with each other.

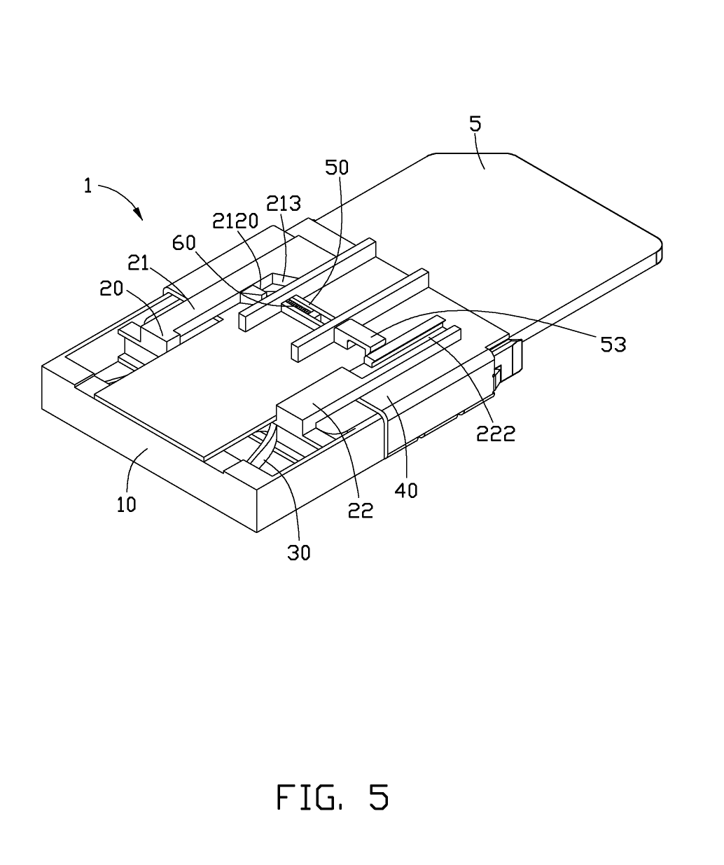

Referring also to FIG. 5, the latching member 50 includes an elongated latching portion 51 and an elastic hook 53 protruding from an end 52 of the latching portion 51. The latching portion 51 includes a latching side surface 511 and a third, end surface 512 opposite to the latching surface 511. The third surface 512 is substantially parallel to the first surface 213 of the ejection member 20. The latching portion 51 further defines an elongated positioning groove 513. The latching portion 51 extends through the guide holes 430 of the covering plate 40, and the positioning block 44 is received in the positioning groove 513. Thus, the latching member 50 is slidable to the housing 10 in a second direction between a first position where the latching portion 51 is on a sliding path of the engaging portion 212 and a second position where the latching portion 51 is moved out of the sliding path of the engaging portion 212. In the embodiment, the second direction is substantially perpendicular to the first direction.

The spring 60 is positioned between the latching member 50 and the positioning block 44 for applying a push force to the latching member 50.

Referring to FIG. 4, the first arm 21 and the second arm 22 rest on the middle plate 41 of the covering plate 40, and the middle plate 41 prevents the ejection member 20 from sliding out of the receiving space 11. When the electrical card 50 is inserted into the receiving space 11 via the entrance 13, the ejection member 20 is pushed by the electrical card 50 and moves into the receiving space 11, causing the second surface 2122 to contact the third surface 512, thereby pushing the latching member 50 to a third position between the first position and the second position, where the elastic hook 53 is unable to engage with the bar 224.

Referring also to FIG. 5, when the engaging portion 212 moves past the latching protrusion 511, a user can stop pushing the electrical card 50. The spring 60 pushes the latching member 50 back to the first position where the latching surface 511 lockingly engages with the engaging surface 2120, thereby preventing the ejection member 20 from being ejected out of the housing 10 by the resilient member 30. Thus, the electrical card 5 is retained within the receiving space 11.

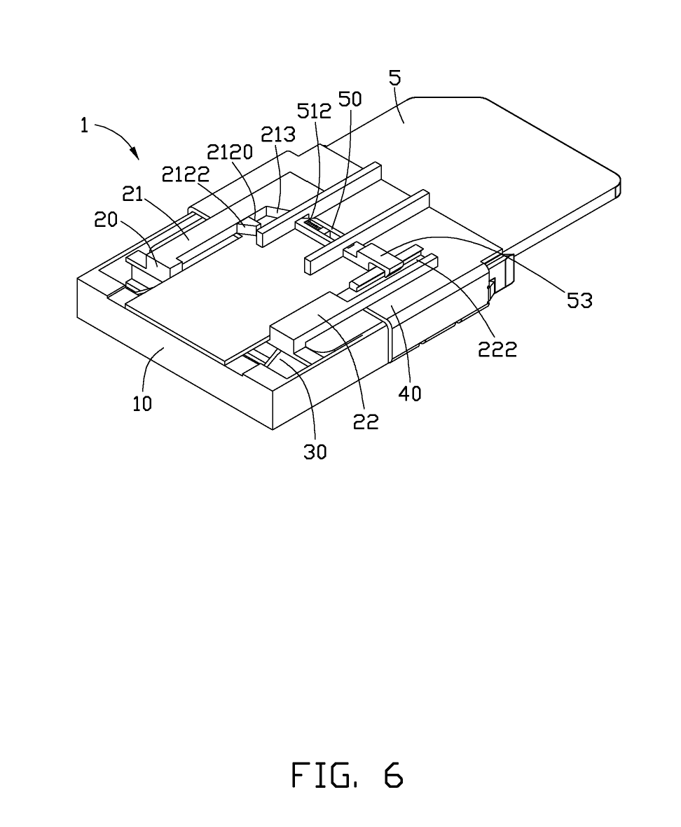

Referring also to FIG. 6, when the electrical card 5 is further pushed, the first surface 213 abuts against the third surface 512 and pushes the latching member 50 toward the second arm 22. When the latching member 50 slides to the second position where the elastic hook 53 locking engages with the bar 224, the user can stop pushing the electrical card 5. The end of the latching member 50 is completely received in the guide hole 430 of one guide block 43, and the latching member 50 does not engage the engaging portion 212. The resilient member 30 then pushes the ejection member 20, and the ejection member 20 pushes the electrical card 5 out of the entrance 13 of the housing 10. The electrical card 5 can then be taken out of the housing 10. During the movement of the ejection member 20, the end of the hook 53 slides in the slot 223. When the end of the hook 53 moves to the open end of the slot 223, the spring 60 pushes the latching member 50 to move and the end of the hook 53 can move out of the open end of the slot 223. The latching member 50 is then pushed by the spring 60 to the position as shown in FIG. 4.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A card connector for accommodating an electrical card, the card connector comprising:
a housing defining a receiving space with an entrance;
an ejection member comprising an ejection portion slidably received within the receiving space and an engaging portion that comprises an engaging surface, the ejection portion being slidable relative to the housing in a first direction;
a resilient member received in the receiving space for applying a push force to the ejection member to move the ejection member toward the entrance; and
a latching member slidably connected to the housing, the latching member comprising a latching portion comprising a latching surface, the latching member slidable relative to the housing in a second direction perpendicular to the first direction between a first position where the latching portion is on a sliding path of the engaging portion and a second position where the latching portion is moved out of the sliding path of the engaging portion;
wherein when driven by insertion of the electrical card into the housing through the entrance, the ejection portion is slidable in the receiving space to a card retaining position where the latching member is located at the first position, the latching surface of the latching portion lockingly engages with the engaging surface of the ejection member urged by the resilient member, thereby preventing the ejection member from moving in a direction away from the housing, while the ejection portion is further slidable inward from a card retaining position to a card releasing position, when driven by further inward insertion of the electrical card into the housing, where the latching member is located at a second position, the latching surface disengages from the engaging surface, thus allowing the resilient member to push the ejection member and the electrical card to move out of the housing.

2. The card connector as described in claim 1, wherein the ejection portion of the ejection member defines a receiving space for receiving the resilient member.

3. The card connector as described in claim 1, further comprising a covering plate fixed on the housing, wherein the latching member is slidably positioned on the covering plate.

4. The card connector as described in claim 3, wherein the ejection member comprises a first arm rested on the cover plate, the first arm comprises a first side surface facing the latching member, and the engaging portion protrudes from the first side surface toward the latching member.

5. The card connector as described in claim 3, further comprising a spring configured for applying a push force to the latching member to move from the first position to the second position.

6. The card connector as described in claim 5, wherein the covering plate comprises a positioning block, the latching member defines a positioning groove receiving the positioning block, and the spring is compressed between the positioning block and the latching member.

7. The card connector as described in claim 3, wherein the first arm comprises a first surface obliquely oriented relative to the first direction, the ejection member comprises a second arm rested on the cover plate, the second arm comprises an upper surface and an elongated bar formed on the upper surface oriented along the first direction, the latching member comprises an elastic hook, and when the ejection portion is moved to the card retaining position to the card releasing position, the first surface pushes the latching member to the second position where the elastic hook of the latching member is lockingly engaged with the bar.

8. The card connector as described in claim 7, wherein the second arm comprises a second side surface facing the first side surface and the upper surface defines an L-shaped slot for guiding the hook to move therein and therealong.

9. The card connector as described in claim 7, wherein the engaging portion comprises a second surface parallel to the first surface, and when the ejection portion is moved from the card retaining position to the card releasing position, the second surface is driven to push the latching member away from the first position to a third position, midway between the first position and the second position, where the elastic hook is unable to engage with the bar.

10. The card connector as described in claim 9, wherein the latching member comprises a third surface parallel to and facing the first surface for contacting the first surface or the second surface when the ejection portion moves between the card retaining position and the card releasing position.

11. The card connector as described in claim 1, wherein the first direction is substantially perpendicular to the second direction.
